(19) United States
(12) Patent Application Publication
(10) Pub. No.: US 2026/0134407 A1
(43) Pub. Date: May 14, 2026

(54) Intelligent Crowd-Sourced Digital Agency Provisioning Systems and Methods

(71) Applicant: Hyper Talent LLC, Stone Mountain, GA (US)

(72) Inventors: Vaughn Pierre Davis, Santa Clarita, CA (US); Andy Xi-Yu Zhang, Los Angeles, CA (US)

(21) Appl. No.: 19/390,248

(22) Filed: Nov. 14, 2025

Related U.S. Application Data
(60) Provisional application No. 63/720,572, filed on Nov. 14, 2024.

(51) Int. Cl. G06Q 50/00; G06F 9/451

(52) U.S. Cl. CPC G06Q 10/40; G06F 9/451

(57) ABSTRACT

The disclosure relates generally to intelligent digital agency systems and methods based on Artificial Intelligence (AI) and Machine Learning (ML) components for building digital profiles for individuals and/or business entities and for provisioning of crowd-sourced digital agency that the individuals and. or business entities can delegate and authorize for facilitating personal and/or business activities and transactions. An Intelligent Digital Agency Engine (IDAE) based on a plurality of AI/ML models is particularly disclosed for automatically generating and maintaining personal, business, and commercial profiles of the individuals and/or business entities by scraping and transforming a variety of external data sources. The IDAE further provides a platform for the individuals and/or business entities to authorize third parties to access or utilize the profiles so as to effectuate digital agencies in the third parties to recommend or providing of personal, business, or commercial service, activities or transactions to the individuals and/or business entities or recommend opportunities or services. Such recommendations or predictions may be intelligently generated by the IDAE according to requests from the third parties, their profiles, the profiles of the individuals or businesses, and other intelligently scraped external data, again relying on a plurality of AI and ML models. The IDAE thus effectively provides an intelligent platform for both proactive opportunity matching and permissioned crowd-sourcing digital agency for recommending and managing personal, business, and/or commercial activities/transactions of the individuals or business entities in an adaptive and targeted manner.

### RELATED APPLICATIONS

This application is based on and claims the benefit of priority to U.S. Provisional Ser. No. 63/720,572 , filed on Nov. 14, 2024, which is incorporated by reference in its entirety.

### TECHNICAL FIELDS

The disclosure relates generally to intelligent digital agency systems and methods based on Artificial Intelligence (AI) and Machine Learning (ML) components for building a digital profile for individual and business entities and for provisioning of crowd-sourced digital agency that the individual and business entities can delegate and authorize for facilitating personal and business activities and transactions.

### BACKGROUND

Handling of personal, business, and/or commercial activities of an individual or a business entity may be performed manually. Personal, business, and commercial decisions may be made based on information known to or acquired by the individual or business entity. Availability of such information may be limited and manual decision process based on such information may be correspondingly limited in effectiveness and efficiency.

### SUMMARY

The disclosure relates generally to intelligent digital agency systems and methods based on Artificial Intelligence (AI) and Machine Learning (ML) components for building digital profiles for individuals and/or business entities and for provisioning of crowd-sourced digital agency that the individuals and. or business entities can delegate and authorize for facilitating personal and/or business activities and transactions. An Intelligent Digital Agency Engine (IDAE) based on a plurality of AI/ML models is particularly disclosed for automatically generating and maintaining personal, business, and commercial profiles of the individuals and/or business entities by scraping and transforming a variety of external data sources. The IDAE further provides a platform for the individuals and/or business entities to authorize third parties to access or utilize the profiles so as to effectuate digital agencies in the third parties to recommend or providing of personal, business, or commercial service, activities or transactions to the individuals and/or business entities or recommend opportunities or services. Such recommendations or predictions may be intelligently generated by the IDAE according to requests from the third parties, their profiles, the profiles of the individuals or businesses, and other intelligently scraped external data, again relying on a plurality of AI and ML models. The IDAE thus effectively provides an intelligent platform for both proactive opportunity matching and permissioned crowd-sourcing digital agency for recommending or predicting and managing personal, business, and/or commercial activities/transactions of the individuals or business entities in an adaptive and targeted manner.

In some example implementations, a method is disclosed. The method may include generating adapted scripts using a first pre-trained model for scraping at least one external data sources to obtain a source dataset; identifying at least one entity and at least one object from the source dataset; generating a plurality of profiles for the at least one entity according to the source dataset using a second pre-trained model, each of the plurality of profiles comprising at least one structured data item and at least one unstructured data item; generating a graphical dataset for representing the at least one entity and the at least one object and relationships there of as extracted from the source dataset; and identifying at least one matching pair between the at least one entity and the at least one object by processing the plurality of profiles and the graphical dataset.

In the example implementations above, the adapted scripts are generated via a user registration procedure.

In any one of the example implementations above, the user registration procedure comprises generating a sequency of adapted inquiries via an user interface for the at least one entity, a later inquiry being adaptively generated by a pre-trained inquiry model based on at least one prior inquiry and at least one response to the prior inquiry provided by the at least one entity.

In any one of the example implementations above, the at least one entity comprises a plurality of individual talents and the at least one object comprises a plurality of brands, venues, events, or service offerings.

In any one of the example implementations above, identifying the at least one matching pair is triggered by one of the at least one entity via a user interface.

In any one of the example implementations above, the user interface comprises a chat box for the at least one entity to trigger the identification of the at least one matching pair by entering textual input in the chat box.

In any one of the example implementations above, the graphical dataset comprises a plurality of nodes representing the at least one entity and the at least one object and a plurality of edges connecting the plurality of nodes and identifying the at least one matching pair is based on predicting a most probably non-existed connection between an entity and an object in the graphical dataset.

In some other example implementation, an electronic system is disclosed. The electronic system may include a memory for storing instructions and at least one processor configured to execute the instructions to perform any one of the methods above.

In some other example implementations, a computer-readable non-transitory storage medium is disclosed. The storage medium is configured to store instructions. The instructions, when executed by at least one processor of an electronic system, cause the electronic system to perform any one of the methods above.

### DRAWINGS

For a more complete understanding of this disclosure, reference is made to the following description and accompanying drawings.

FIG. 1 shows an example Intelligent Digital Agency platform for providing crowd-sourced digital agency.

FIG. 2 illustrates example types of user application and/or devices that can interact with the Intelligent Digital Agency platform of FIG. 1.

FIG. 3 illustrates example components of the Intelligent Digital Agency platform of FIG. 1.

FIG. 4 illustrates an example process for adaptively building profiles of individuals or business entities in the Intelligent Digital Agency platform of FIG. 1.

FIG. 5 illustrates an example platform for applying the Intelligent Digital Agency platform of FIG. 1 in provisioning digital agency for individual talents.

FIG. 6 illustrates a computing component that can be used as part of the Intelligent Digital Agency platform of FIGS. 1-5.

### DESCRIPTION OF THE DISCLOSURE

Various example implementations will now be described in detail hereinafter with reference to the accompanied drawings, which form a part of the present disclosure. The systems, devices, and methods disclosed herein may, however, be embodied in a variety of different forms and, therefore, the disclosure herein is intended to be construed as not being limited to the embodiments set forth below. Further, the disclosure may be embodied as methods, components, and/or platforms in addition to the disclosed devices and systems. Accordingly, embodiments of the disclosure may, for example, take the form of hardware, software, firmware or any combination thereof.

In general, terminology may be understood at least in part from usage in its context. For example, terms, such as “and”, “or”, or “and/or,” as used herein may include a variety of meanings that may depend at least in part upon the context in which such terms are used. Typically, the term “or”, if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for the existence of additional factors not necessarily expressly described, again, depending at least in part on context.

Many other modifications of the implementations above may be made to adapt a particular situation or material to the teachings without departing from the scope of the current disclosure. Therefore, it is not intended that the present methods and systems be limited to the particular embodiments disclosed, but that the disclosed methods and systems include all embodiments falling within the scope of the appended claims.

By way of introduction, handling of personal, business, and/or commercial activities of an individual or a business entity is traditionally performed by a manager or agent of the individual or business entity. Such individuals needing managerial or agency assistance may include but are not limited to talents (athletes, entertainers, performers, influencers, and the like) and celebrities of various types. Business entities needing such managerial or agency assistance may be more prevalent. In the context of this disclosure, differentiation of such individuals or business entities is not made unless expressly indicated. Such individuals or businesses may be collectively referred to as entities. The personal, business and/or commercial activities being managed by their agents or managers may include but are not limited to event planning, event attendance, venue selections, identification and development of endorsement deals, match up with brands, conflict management in commercial activities, commercial transaction management, contract management, personal services (e.g., medical appointment), insurance management, supplier management, customer services, and the like.

The agents or managers may be involved in detailed collection and analysis of information. Because such information can be overly voluminous and noisy, the decisions by the agents or managers may not always be optimal or timely.

In the disclosure below, an intelligent platform is described to effectively implement a permissioned crowd sourcing of the traditional agency and management such that the personal, business, and/or commercial activities and opportunities for the entities can be more optimally managed, identified, and facilitated. Third parties, including but not limited to personal or business service providers, brands, brokers, deal matchers may be authorized by an entity to voluntarily interact with the intelligent platform to formulate recommendations, predictions, and proposals and to provide consultation to the entity and to communicate such recommendations, predictions, and proposals to the entity or representatives/delegates of the entity.

As an overview, the further disclosure below relates generally to intelligent digital agency systems and methods based on Artificial Intelligence (AI) and Machine Learning (ML) components for building digital profiles for individuals and/or business entities and for provisioning of crowd-sourced digital agency that the individuals and. or business entities can delegate and authorize for facilitating personal and/or business activities and transactions. An Intelligent Digital Agency Engine (IDAE) based on a plurality of AI/ML models is particularly disclosed for automatically generating and maintaining personal, business, and commercial profiles of the individuals and/or business entities by scraping and transforming a variety of external data sources. The IDAE further provides a platform for the individuals and/or business entities to authorize third parties to access or utilize the profiles so as to effectuate digital agencies for the third parties to recommend or provide personal, business, or commercial service, activities or transactions to the individuals and/or business entities or recommend opportunities or services. Such recommendations or predictions may be intelligently generated by the IDAE according to requests from the third parties, their profiles, the profiles of the individuals or businesses entities, and other intelligently scraped external data, again relying on a plurality of AI and ML models. The IDAE thus effectively provides an intelligent platform for both proactive opportunity matching and permissioned crowd-sourcing of digital agency for recommending and managing personal, business, and/or commercial activities/transactions of the individuals or business entities in an adaptive and targeted manner.

Merely as one practical example, the IDAE described above and in further detail below may provide a management and digital agency service to an individual talent, who may need to have his/her personal, business, and commercial activities and opportunities optimally managed and evaluated. The system may allow the individual talent to give permission to third parties to identify services, match deals, match brands, finding endorsement, arrange events, and the like for the individual talent. The IDAE thus enables the individual talent to crowed source his/her personal, business, and commercial activities and opportunity management to many third parties. The IDAE thus can adaptively multiply representation of the individual talent through such permissioned crowd-sourcing of digital agency. The IDAE may generate and maintain a profile for the individual talent. The third parties in the crowd may interact with the IDAE with requests and ideas. The IDAE may generate recommendations, predictions, proposals, and/or plans for deals, brands, and services adaptively based on the requests from the third parties and the profiles maintained by the IDAE. These third parties may be profiled and evaluated or qualified by the IDAE so that they provide a quality of agency that is at least of a configurable threshold level. The IDAE is configured to provide various interfaces and/or portals to the individual talents, third parties in the crowd, business, venues, brands to access the IDAE with various permission and authorization levels. Interaction with the IDAE, for example, may be provided via a chatbot and thus only unstructured information needs to be provided to the IDAE for anyone accessing the system.

While the various implementations summarized above and described in detail below may be provided with reference to adaptive crowd-sourced digital agency to individual talents at times, the underlying principle applies to adaptive crowd-sourcing of digital agency to other individuals and/or business entities.

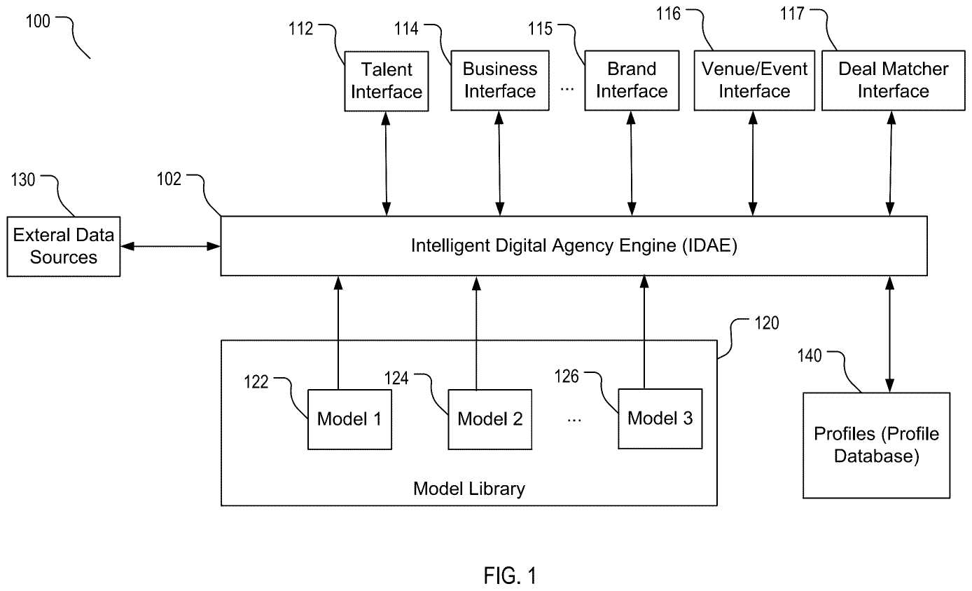

FIG. 1 illustrates an example intelligent digital agency platform (IDAP) 100. The intelligent digital agency platform 100 may include an intelligent digital agency engine (IDAE) 102 providing a plurality of user interfaces 112 through 117 that can be accessed by various individual or business entities (generally referred to as entities) being served by the IDAP, and third parties that seek to provide services or representation to the entities. The user interfaces 112-117 may be provided in various forms. The user interfaces 112-117 may be specifically configured and formatted for different types of entities and third parties. For example, a specific user interface may be configured for individuals of different talents to manage their profiles and authorizations to the third parties, as shown by 112. Likewise, specific user interface may be configured to different types of business entities, as shown by 114. Third parties providing business services may be configured with user interface 114. Brand names looking for representation may be provided with user interface 115. Venue providers or event organizers may be provided with specific type of user interface 116. Third party deal facilitators or deal matchers may be provided with user interface 117. These user interfaces may be generated using trained AI models that adapt to particular functions and characteristics of these entities and parties.

In some example implementations, an individual or business may be both an entity needing service in one aspect or a third party taking a role of facilitating services and thus may be provided with multiple user interface for their different roles or may be provided with a single multi-function user interface. The various entities and third parties may be serviced by the IDAS 100 as registered users. Each of these registered users may be registered with specific roles or a combination of roles. The roles of the registered user, as described above, may include being an entity (individual or business) that the digital agency may be provided to, or being a third party that provides services to the entities, or being a third party that facilitates connection between the entities and service providing parties.

The example IDAE 102 of FIG. 1 may further communicate with various external data sources 130 for scaping current and historical data relevant to the various entities and parties. As described in further detail below, the various data scraped from the external data sources 130 may be further filtered and utilized for building profiles for the various entities and third parties.

The example IDAE 102 may further communicate with a model library 120. The model library 120 may be configured to maintain a plurality of AI models 122, 124, and 126 and other data analytics models. These models may be rule based or may be pre-trained using historical datasets, such as various language models for processing textual data and pretrained models for processing audio, video or image information. The IDAE 102 may request data processing by any of these models in order to achieve its functions described below.

The example IDAE 102 may be further connected to a profile database 140 such that the IDAE 102 can generate and maintain profiles of the various entities and third parties and retrieve these profiles when providing intelligent digital agency service to the entities and third parties.

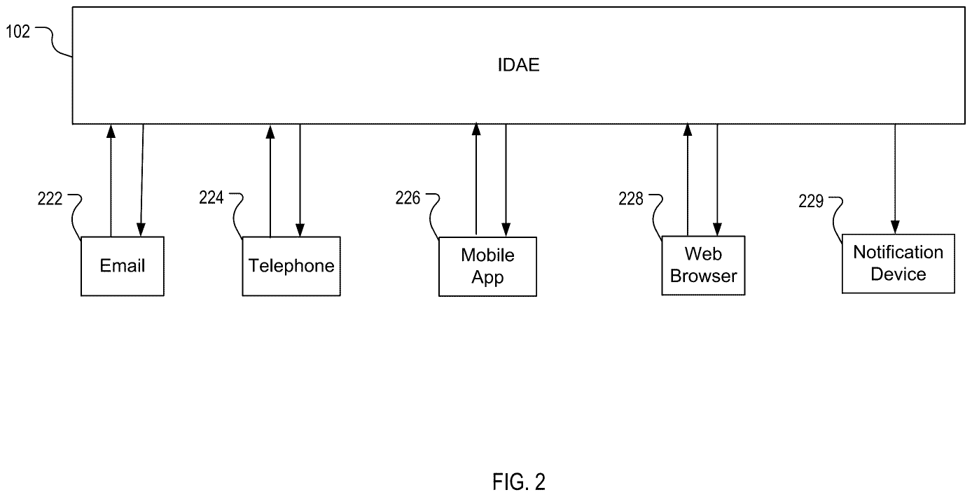

The various user interfaces 112-117 may be implemented via different types of user devices and applications, as further illustrated in FIG. 2. As shown in FIG. 2, example types of applications or devices that interact with the IDAS 102 may include but are not limited to email apps or devices (222), other mobile apps or devices (226), telephone apps or devices (224), web browser apps or devices (228), and the like. The user interfaces 112-117 may be further configured to perform notification and reporting functions in addition to functioning as user input interface. Notification and reports may be provided as emails, text messages, images, file attachments, audio alerts, and the like. The user apps or devices 222-228 may be used to carry the notification function. Other types of notification apps or devices 229 may also be connected to the IDAE 102, including but not limited to paging apps or devices, alarm apps or devices, and the like. These notification apps or devices may only receive notification information, alert, or be prompt from the IDAE 102 to perform the notification function as shown by the single direction arrow from the IDAE 102 to the notification apps or devices 229. Alternatively, these apps or devices may be configured to receive user input or commands and transmit such user input or commands to the IDAE 102.

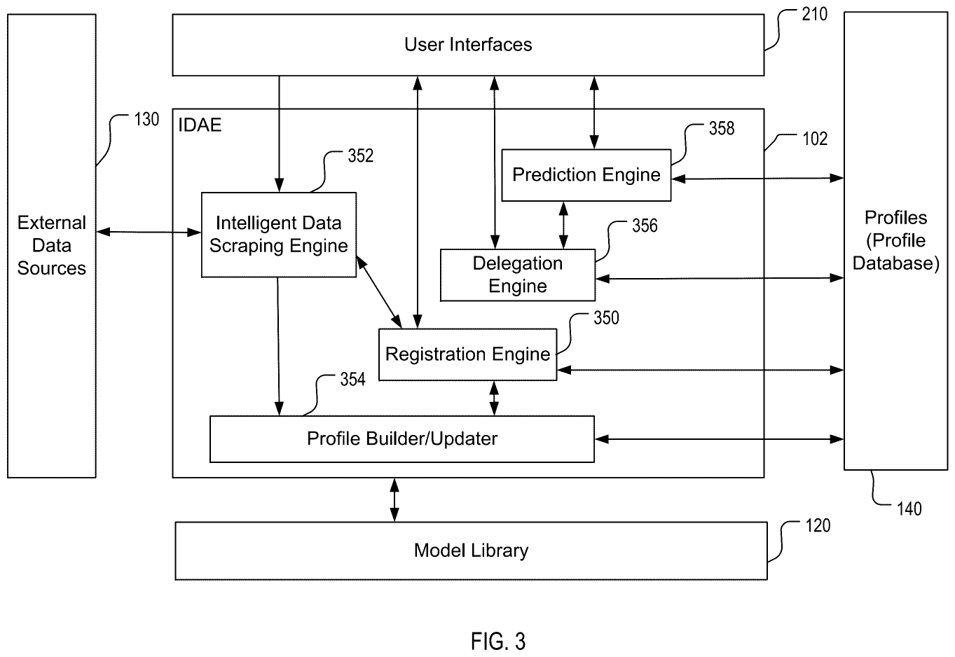

FIG. 3 shows various example components of IDAE 102 for achieving an intelligent digital agency platform. The example IDAE 102 of FIG. 3 may include a registration engine 350, an intelligent data scraping engine 352, a profile builder/updater (alternatively referred to as profile engine) 354, a delegation engine 356, and a recommendation engine or prediction engine 358, among other components not explicitly shown in FIG. 3.

The IDA 102, for example, may include the registration engine 350 configured to manage access and usage control of users of the IDAE 102. The registration engine 350 may be configured to intake requests to create user accounts for various entities and third parties. The user accounts may be of different types, including but not limited to entity accounts and third-party accounts. Various levels of access privileges may be pre-defined and the user accounts may be attributed or attached with one of the pre-defined access privileges. The establishment of user accounts may be based on response to inquiries from the users via a specific registration user interface among the user interfaces 210. A set of basic inquiries may be prompted in the registration user interface for a potential user to provide answers. Depending on the types of users, different sets of inquires may be prompted. In some example implementations, the inquiries for a registration process may be configured as an intelligent progressive procedure in that the inquiries prompted to a user may be adaptively and progressively generated by the registration engine in sequence, with a later inquiry dependent on user's answer to one or more proceeding questions. Such dependency may be embedded in an AI/ML model pulled from the model library 120. Such an AI/ML model may be pretrained and may be configured to generate a sequency of questions based on rolling answers from the users and to terminate when the model determines that sufficient information has been collected from the user in order to determine registration and generating a profile. Such an AI/ML model may further ingest current data pulled from the external data to intelligently generating the sequence of registration inquiries.

The IDAE 102 may further include the profile engine 354. The profile engine 354 may be configured to generate and maintain user profiles, including profiles of the registered entities (individuals or businesses) and third parties. The Profile engine 354 may communicate with the registration engine 350 and the intelligent data scraping engine 352 to obtain information items in order to generate user profiles. The profile engine 354 may maintain the user profiles in the profiles database 140. The user profiles generation and maintenance, as described in further detail below, may constitute an essential aspect of the IDAE 102. The user profiles may be generated so as to contain information of each user (individual or business entity or third party) that form the basis for the recommendation or prediction for providing the digital agency service to, e.g., An individual or business entity. The user profile may be stored as structured data items with predefined fields or as unstructured documents, or a combination thereof. Correspondingly, the underlying datastore or database for holding the profiles may be segregated into structured portion and non-structured portion. The structured portion, for example, may be stored in a relational database whereas the unstructured portion of the user profiles may be maintained and stored in a NoSQL database. The profile engine 350 may be configured to pull various AI/ML models from the model library 120 to screen, filter, and transform the scraped data from the external data relevant to each particular user as well as the user data obtained from the registration engine to generate a profile for the particular user. Each of the user profiles maintained in the profile database 140 may be kept up-to-date by running the profile engine 354 on set time, periodically, or as triggered by occurrence of an event associated with a particular user.

An example user profile may include but is not limited to personal information, medical records, biography, historical events, performances, current and past endorsement, business records, education backgrounds, publications, awards, contact information, followers, social network activities, and the like. The structured or unstructured components of a profile may include textual documents, pre-formatted tables, images, voice recordings, press releases, and the like. In some implementations, these profiles may be stored in a pre-embedded vector space for fast usage. Such pre-embedded vector space, for example, may be generated using a pre-trained AI model such as a neural network model.

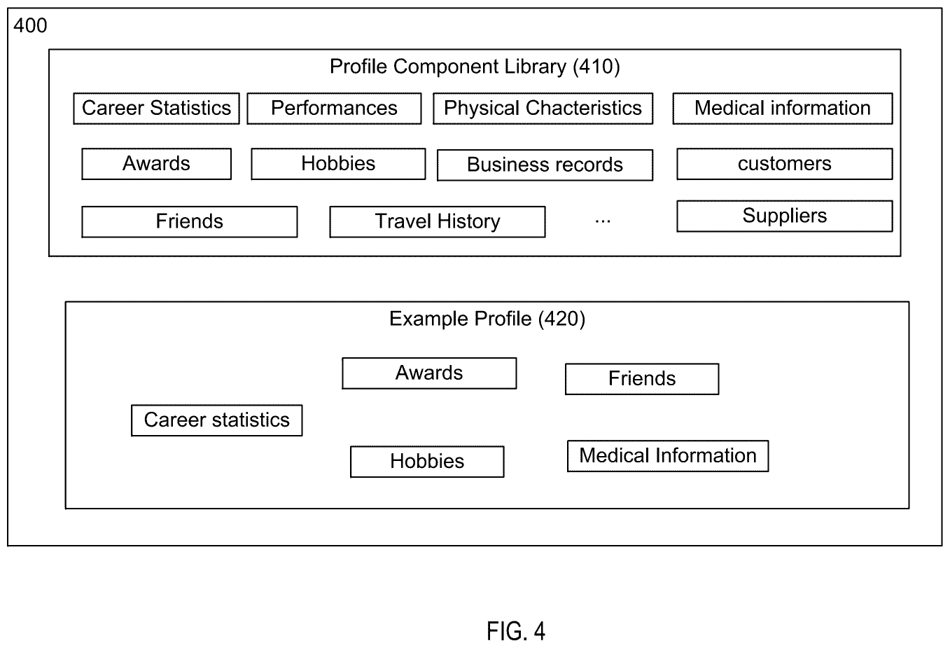

FIG. 4 illustrates an example process 400 for building a user profile. As an example, The user profile may include a plurality of structured or unstructured components. Then number of and the composition of the components may be adaptively determined and selected by the profile engine 354. Type of components for the profiles may be predetermined, as shown in the profile component library 410. These components define information/data category that could be included in a particular profile, given a scope of the digital agency service provided by the IDAE 102 and the range of entities and third parties it serves. When building a profile for a particular user, the profile engine 354 may determine and select suitable components from the profile component library 410 that should be included based on, for example, data items collected during the registration process of the particular user. In the example profile 420 of FIG. 4, the particular user is an athlete, and the profile engine 354 determined that the “career statistics”, “Awards”, “Hobbies”, “Friends”, “Medical Information” components are to be included in his/her profile.

In some example implementation, the profiles may be generated as linked data objects. Each profile may be represented by a node in, for example, a graphical data stored in a graphical basebase. The profile nodes may be connected by edges that represent relationship between the corresponding users. Each profile object may be linked to the actual profile in the profile database 140. The profile objects and their relationship may be specified and may be stored in a database as part of or separate from the profile database 140. The profile objects and their relationships may be utilized by the prediction engine as part of its input for generating intelligence digital agency service.

Returning to FIG. 3, the IDAE 102 may further include the intelligent data scraping engine 352. The scraping engine 352 may be configured to adaptively and intelligently generate API scripts based on user registration information and interact with application interfaces of the external data sources, including but not limited to subscribable or open access data sources, such as news outlets, advertisement platforms, social networks, search engines, AI platforms (e.g., open AI ChatGPT), governmental information repositories, county data registry, business websites, and the like. In some example implementations, the adaptive API scripts may be generated according to the user registration data.

As further shown in FIG. 3, the IDAE 102 may further include the delegation engine 356. The delegation engine 356 may be configured to provide permissioned digital agency. It may manage the level or scope of permission of representation between users, e.g., each entity may be provided with an ability to allow or disallow any other entity or parties to access his/her profiles to provide digital agency service, or to control the level and scope of representation. In some example implementations, each entity may give automatic delegation decision to the IDAE. The delegation engine 356 may in turn be configured to analyze the profile of a party requesting to represent an entity to determine whether permission should be given. The determination may, again, be performed by an AI/ML model from the AI model library that is pre-trained.

The IDAE 102 may further include the prediction engine 358, as shown in FIG. 3. The prediction engine 358 may be configured to perform the core function of allowing a third party with permission to identify digital agency services and representation of an entity.

In some example implementations, the user interface provided to a party or entity may be provided a chat box. The user may input available opportunities or services that may be rendered. The input into the chat box may be unstructured in nature. The prediction engine 358 may be configured to identify the nature of the opportunities or services and then predict a set of entities that may be interested in such opportunities or services. The prediction may be based on a pretrained AI/ML model that takes entity profiles and the identified opportunities or services as input. The list of candidate entities may be automatically summarized and reported to the requesting party via his/her access user interface. The party may be allowed to select target entities from the user interface so that the IDAE can automatically communicate a recommendation or prediction to the selected target entity or entities (via, e.g., email, text messaging, or as a recommendation or prediction item within the user interface of the target entity or entities).

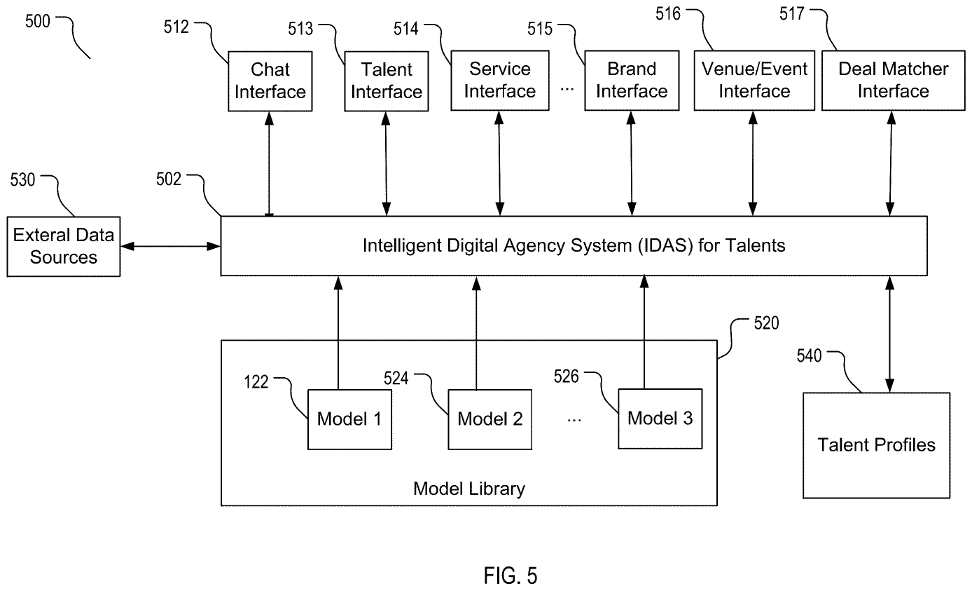

FIG. 5 further illustrates an application of the system of claim 1 to the talent management and agency context. The description above applies and the entities being serviced include at least various types of individual talents. Other parties are provided with a user interface to recommend or predict services (personal or business), brand deals, events suggestions, and the like.

While the example implementations above are described as crowed sourced digital agency, in some alternative implementations, the prediction engine 358 may, automatically, proactively, periodically, or by other triggering conditions, generate ranked matching pairs between the entities, or between the entities and various objects extracted from external data sources and recommend such matching parties to the entities. Such proactive matching prediction and recommendation would not involve crowd sourcing of digital agency to other third parties and may be prompted by any party or triggered by any events or conditions.

In some example implementations, graph manipulation techniques may be used to implement the profile management and recommendation or prediction process above. For example, the profile objects and their relationship may be implemented as a graphical data and stored as a graphical database as a part of or separate from the profile data base 140.

An example basic graphical data implementation for the crowd-sourced intelligent digital agency system such as a talent-brand ecosystem, may include:
Nodes (or Vertices) for representing entities and third parties in the system. In the context of talent management, these typically fall into several categories: talent nodes (e.g., influencers, creators, celebrities), brand nodes (companies seeking partnerships), campaign or opportunity nodes (specific marketing initiatives), and auxiliary nodes like audience segments, content categories, or geographic regions.
Edges (Connections) represent relationships between these entities and third parties. In the context of talent management, these relationships may include past collaborations between talent and brands, audience overlap metrics, content affinity scores, engagement relationships, or potential partnership compatibility scores.

The graph can be directed (where relationships have direction, like “influencer A reaches audience segment B”) or undirected (mutual relationships like “brand X and talent Y have collaborated”). Edges often carry weights representing the strength, value, or probability of a connection.

In some example implementations, the graph may be bipartite. For example, in the context of talent management, the talent-brand matching problem naturally forms a bipartite graph structure, where nodes are divided into two distinct sets (talent and brands), and edges only connect nodes from different sets. This structure is particularly useful for visualizing the entire partnership landscape, identifying market gaps where certain brands lack talent connections, finding talent that bridges multiple brand categories, and analyzing competitive partnership patterns.

In some example implementations, various algorithms may be applied to the graph above for the prediction engine 358 of FIG. 3 to, e.g., match talents with brand.

As an example of a Matching Algorithm, a Maximum Bipartite Matching scheme may be implemented to help find the optimal set of talent-brand pairings that maximizes the total number of successful partnerships. When weights representing partnership value (based on audience reach, engagement rates, or projected ROI) are added, a Hungarian Algorithm can be employed to find the optimal assignment that maximizes total value while ensuring each talent is matched to at most one brand campaign at a time.

In some example implementations for more complex scenarios where talent can work with multiple brands (with capacity constraints), a network flow algorithm including but not limited to Ford-Fulkerson method can be employed to optimize the distribution of talent across multiple campaigns while respecting exclusivity agreements and time constraints.

In some example implementations, centrality measures in the graph may be utilized for matching. For example, different centrality metrics may reveal different aspects of influence in the talent-brand network. For example, a Degree Centrality may help identify talent with the most brand connections, indicating versatility and market validation. High degree centrality for brands shows which companies are most active in influencer marketing. For another example, a Betweenness Centrality may be generated to reveal talents who serve as bridges between different brand categories or audience segments. These talents (e.g., influencers) may be valuable for brands looking to reach new demographics or cross-promote between industries.

In some example implementations, Eigenvector Centrality may be used for facilitate matching by the prediction engine 358. Such eigenvector centrality not only measures the number of connections but also measures the connection quality. For example, talent connected to highly influential brands score higher, indicating premium partnership potential.

In some example implementations, a pager rank adapted from web search may be considered by the prediction engine 358 to identify talent whose influence propagates through the network, considering both direct audience reach and secondary influence through peer networks.

In some example implementations, analytics on the graph above may provide community detection. Such analytics for community detection may involve a clustering algorithm, including but not limited to Louvain or Label Propagation algorithms, which may help identify natural groupings in the talent-brand ecosystem, such as talent communities that frequently work with similar brands; brand clusters that compete for the same talent pool; audience segments that respond to specific talent-brand combinations, and/or geographic or demographic clusters that inform regional campaign strategies. These communities, once identified, may help brands identify untapped talent pools and understand competitive dynamics in the influencer marketplace.

In some example implementations, path analysis may be performed by the prediction engine 358 on the graph above. For example, a Shortest path algorithms (including but not limited to Dijkstra's algorithm) may be implemented to trace connection paths between talent and target audiences, helping brands understand how to reach specific demographics through influencer networks. For another example, a Multi-hop analysis may be implemented to reveal how influence propagates through networks-for instance, how a macro-influencer's content gets reshared by micro-influencers to reach niche audiences.

In some example implementations, a prediction modeling may be implemented by the predictionn engine 358 on the graph above. The predictive model, by analyzing the graph structure over time, may be capable of predicting at least one of:
Emerging talent before they become mainstream (by detecting rapidly growing node connections).
Likely success of talent-brand partnerships based on similar historical pairings.
Market saturation points where certain talent-brand categories become overcrowded.
Optimal timing for partnership announcements based on network activity patterns.

In some example implementations, the prediction engine 356 may include a model to perform risk assessment abased on the graph structure above. Such graph analysis may help identify and mitigate risks including but not limited to:
Overexposure detection for identifying talent working with too many competing brands.
Authenticity scoring for measuring whether talent-brand matches align with historical patterns.
Crisis propagation modeling for understanding how negative events might spread through connected networks.
Exclusivity violation detection for automatically flagging potential contract conflicts.

In some example implementations, the prediction engine 356 may be configured to perform a Return of Investment (ROI) optimization on the graph structure above. Such optimization of the graph structure may enable sophisticated ROI calculations, including but no limited to:
Attribution modeling through influence paths.
Synergy identification between complementary talent in multi-influencer campaigns.
Audience overlap optimization to minimize redundant reach.
Sequential campaign planning using temporal graphs.

Building an effective graph structure above may involve comprehensive data about the entities and their relationships, including but not limited to:
Historical partnership data
Audience demographics and psychographics
Engagement metrics across platforms
Content performance data
Brand affinity scores
Competitive intelligence

Such information, as described above, may be obtained from the registration process and scaping of the external data source 130 via the intelligent data scraping engine 352 of FIG. 3 above. The graph structure above, may be frequently maintained and updated in a automatic manner, as the talent-brand graph is highly dynamic. Such maintenance and update may involve one or more of:
Real-time edge weight updates based on engagement metrics.
Periodic node addition/removal as talent and brands enter/exit the market.
Temporal modeling to capture seasonal trends and campaign cycles.
Version control to track graph evolution and measure prediction accuracy.

The graph structure above may be constructed in a scalable manner so that it can be efficiently expanded to millions of nodes and edges. The scalability of the graph structure may involve implementation of efficient storage and querying and usage of distributed computing for complex algorithm execution, real-time recommendation/prediction generation, and an integration with existing marketing technology stacks.

The implementation of graphical data above may help adding objectivity talent-brand matching and may enable (1) data-driven (rather than subjective) decision making that moves beyond intuition to mathematically optimal partnerships, (2) market intelligence through comprehensive ecosystem visualization and competitive analysis, (3) efficiency gains through automated matching and reduced search costs, (4) risk mitigation through systematic conflict detection and authenticity verification, and (5) innovation opportunities by discovering non-obvious partnerships and emerging talent.

In some example implementations, the graph approach above also provides a common language and framework for different stakeholders-talent agencies, brands, and platforms-to understand and optimize the influencer marketing ecosystem. As the creator economy continues to grow and complexify, graph theory becomes increasingly essential for navigating and capitalizing on the vast network of potential partnerships.

By treating talent-brand relationships as a living, analyzable network rather than isolated transactions, organizations can build sustainable competitive advantages in influencer marketing and creator partnerships. The mathematical rigor of graph theory, combined with domain expertise in marketing and talent management, creates a powerful toolkit for the modern digital marketing landscape.

In some example implementations, an Infinity Category Graph may be implemented, which represents a Higher-Dimensional graph. Specifically, infinity category graphs represent one of the most sophisticated extensions of traditional graphs, emerging from higher category theory and homotopy theory. While standard graphs capture binary relationships between nodes, infinity categories allow for modeling of relationships between relationships, continuing infinitely up the dimensional hierarchy. In the context of talent-brand mapping, this framework offers a radically more nuanced way to understand the complex, multi-layered nature of modern influencer ecosystems.

An infinity categorical framework move beyond simple nodes and edges to consider:
morphisms: The objects themselves (talent, brands, campaigns)
morphisms: Direct relationships (partnerships, collaborations)
morphisms: Relationships between relationships (how one partnership influences another)
n-morphisms: Higher-order relationships continuing indefinitely

This hierarchy implementation help capture the reality that in the talent-brand ecosystem, relationships don't exist in isolation—they influence, modify, and contextually depend on each other in ways that traditional graphs cannot fully represent.

The infinity categorical framework may used to implemented a multi-platform Talent Network. For example, consider how a single influencer operates across multiple platforms (Instagram, TikTok, YouTube, podcasts). In a traditional graph, these objects may be represented as separate edges to different platform nodes. However, an infinity categorical approach recognizes that (1) the relationship between an influencer and Instagram modifies their relationship with TikTok (cross-platform content strategies), (2) the way these platform relationships interact with themselves depends on the temporal sequencing of content (a 3-morphism), (3) the strategic decisions about platform prioritization create even higher-order relationships that evolve based on algorithm changes and audience migration patterns.

The infinity category framework of graph thus create a rich structure where each level of relationship carries meaningful business intelligence about platform synergies, content strategy optimization, and audience journey mapping.

In some example implementations, the infinity category frame work may facilitate modeling of evolution and transformation. For example, infinity categories excel at representing how relationships transform over time. In the talent-brand space, this captures several critical dynamics:
Partnership Evolution Paths: A talent-brand relationship doesn't simply exist or not exist—it travels through a complex evolution space. Initial contact, negotiation, collaboration, and ongoing relationship maintenance form a path through the infinity categorical space. Different paths between the same endpoints (talent and brand) represent different possible partnership trajectories, each with its own risk profile and expected outcome.
Homotopy Classes of Campaigns: Campaigns that can be continuously deformed into each other (in terms of strategy, messaging, or execution) belong to the same homotopy class. This mathematical framework helps identify which campaign variations are genuinely different versus cosmetically distinct, informing creative strategy and budget allocation.
Higher-Order Market Dynamics: The interaction between multiple talent-brand partnerships creates interference patterns that infinity categories can model. For example, when Influencer A partners with Brand X, and Influencer B partners with Brand Y, the interaction of these partnerships in the market creates a 2-morphism. If Brands X and Y later merge, the historical partnership patterns create higher-order constraints on future talent relationships.

In some example implementations, the infinity categories may be implemented to provide compositional Intelligence. For example, one of the most powerful aspects of infinity categories is their sophisticated notion of composition. In practical terms, this means:
Provision of Strategic Pathway Composition: When planning multi-stage influencer campaigns, the infinity categorical structure reveals how different sequential partnerships compose. The path “nano-influencer→micro-influencer→macro-influencer” has different compositional properties than attempting to directly engage macro-influencers, and these differences are captured in the higher categorical structure.
Enablement of Audience Journey Functors: The movement of audiences through the influence network can be modeled as functors between infinity categories. These functors preserve the essential structure of influence relationships while mapping between different contexts (geographic regions, demographic segments, or temporal periods).
Enforcement of Coherence Conditions: Infinity categories enforce sophisticated coherence conditions that, in the business context, represent consistency requirements. For instance, if a beauty brand's partnerships must maintain coherent messaging across all talent relationships, the infinity categorical framework ensures that all higher-order relationships respect this constraint.

The above implementations may be provided as methods, systems, infrastructures, backend servers, and devices. In some other example implementations, secure portals may be provided for and accessible by individual talents, groups of talents, agents of the talents, brands, venues, event organizers, legal professionals, and other entities associated with professional, social, and economic activities of the talents. Each of the portals may be adapted to manners for efficiently viewing, provisioning, and management of tasks of each accessing entity. The portal may be accessed, for example, as a web client or other dedicated client programs. The back-end servers may be holistically configured to spool and collect a range of raw data of various format and from various sources, to process such raw data, and to generate data items supplied to the portals.

In some example implementations, the operational tasks of the systems may be provided by teams that are organized into various departments and sub departments with the departments. The team members may also be provided access to the system portals in order to interact with the talents, their agents, the brands, and other entities, and to update the system information.

In some example implementations, the various example departments, their functions, and their interactions with the talents, the agents, the brand, and other entities are provided below.

In some example implementations, access may be provided to talent representation and client management department. For example, such a talent provisioning and management system may be driven by a first department for talent representatives or agents, which perform talent presentation and client management functions that may be accessed and provisioned via representative or agent portals. A reprehensive/agent workflow and tasks may include but is not limited to:
Agents and managers handle daily communication and relationship management with clients (talents), ensuring that their career goals are met through contract negotiations, endorsements, and strategic guidance.
They work with internal teams such as legal, marketing, and PR to execute deals and optimize career opportunities for clients in sports, entertainment, and digital media.
Data analytics and AI tools are often leveraged to track the success of deals and identify new opportunities for growth.

The talent representation and client management department may involve and/or interact with: Talent Agents; Client Services department; and/or Legal and Contracts entities described further below.

In some example implementations, access may be provided to a Brand Strategy and Marketing Department with the following workflow overview:
Marketing teams focus on building the personal brands of clients through partnerships, sponsorships, and strategic campaigns.
AI-driven insights are used to identify brand alignment, audience engagement, and market trends.
Marketing and PR teams collaborate to secure public speaking engagements, brand deals, and social media activations, aligning them with the client's career trajectory.
Campaign performance is continuously monitored and optimized for reach and engagement.

The brand strategy and marking department may involve and/or interact with: Marketing and Brand Strategy team; Public Relations (PR) team; and/or Digital Strategy and Content Creation team, described above or below

In some example implementations, access may be provided to a Contract Negotiation and Legal Department with the following workflow overview:
The legal team ensures that every deal, from brand partnerships to sponsorships, is legally sound and beneficial for the client.
Contract negotiations focus on securing the best terms for talent, whether in terms of financial compensation, creative control, or additional perks.
Internal collaboration with agents ensures deals align with the client's overall career strategy.

The Contract Negotiation and Legal Department Key Departments may involve and/or interact with: Legal and Contracts team; Talent Agents; and/or Financial Advisory team described above or below.

In some example implementations, access may be provided to a Business Development & Partnerships Department with the following work flow overview:
Business development teams focus on expanding opportunities for clients by identifying new markets, emerging industries, and untapped revenue streams.
They work closely with marketing teams to create partnerships that align with both client interests and business goals, often leveraging the agency's vast network of corporate and industry contacts.
Regular updates and reports help monitor the performance and growth potential of existing partnerships.

The Business Development & Partnerships Department Key Departments may involve and/or interact with: Business Development team. Marketing and Sponsorship team; and/or Strategic Partnership team described above or below.

In some example implementations, access may be provided to a Content Creation & Social Media Management department with the following work flow overview:
Creative teams work with clients to produce content that amplifies their personal brand across digital and traditional media platforms.
AI and analytics tools are used to track audience engagement, measure campaign success, and refine content strategies in real-time.
Social media managers create and execute tailored digital strategies, ensuring alignment with broader marketing goals.

The Content Creation & Social Media Management department may involve and/or interact with: Creative and Digital Teams; Social Media Managers; and/or Content Strategy & Development team described above or below.

In some example implementations, access may be provided to a Client Onboarding & Success department with the following work flow overview:
Client onboarding ensures a seamless transition into the agency's ecosystem, starting with a comprehensive assessment of the client's career goals, market positioning, and branding needs.
The agency establishes clear communication channels and strategies to monitor the client's progress and align actions with their long-term objectives.
Continuous performance reviews and updates allow for course correction and optimization.

The Client Onboarding & Success department may involve and/or interact with: Talent Management team; Client Service team; and/or Data & Performance Analytics team described above or below.

Members of the various example departments above may be classified into different categories of entities. Each of the entities may be provided with a portal to the talent provisioning and management system, as described in further detail below.

In some example implementations, the Talent Representation & Client Management may involve the following classes of entities:
Talent Agents,
Client Services Managers,
Legal & Contracts professionals.

An example weekly workflow of tasks for these entities may include:
Client Communication & Relationship Management: Agents regularly check in with clients, addressing current deals, career goals, and any upcoming opportunities (e.g., endorsements, speaking engagements). Weekly, they provide updates on new potential deals or partnerships.
Strategy Sessions: Agents work with the marketing and business development teams to strategize the client's next moves. These include long-term career planning and exploring new market opportunities.
Contract Negotiations: Agents and legal teams negotiate contracts for brand partnerships, sponsorships, and endorsements. Contracts are reviewed, modified, and finalized through meetings and back-and-forth with legal teams to ensure beneficial terms for both the client and the agency.
Client Reporting: Agents prepare a report detailing the status of current engagements, upcoming opportunities, and financial updates, and present it to clients by the end of the week.

In some example implementations, the Marketing & Brand Development may involve the following classes of entities:
Marketing Managers,
Brand Strategists,
Social Media Managers.

An example weekly workflow of tasks for these entities may include:
Campaign Planning: The week starts with brainstorming and strategizing marketing campaigns tailored for each client, including digital and traditional media strategies. The brand team works with social media and creative teams to plan content releases, sponsorship activations, and media coverage.
Content Creation & Review: Brand strategists and creative teams generate social media posts, articles, digital content, and visuals to align with the client's personal brand. Social media managers schedule and optimize posts based on analytics, ensuring maximum audience engagement.
Engagement & Analytics: Social media managers continuously monitor the performance of posts and campaigns, tweaking strategies based on real-time audience behavior data. By midweek, they meet with marketing and brand strategists to evaluate progress and reallocate resources where necessary.
Partnership Pitches: Marketing teams focus on pitching brand partnership opportunities to external companies, positioning clients for high-value deals. They prepare pitch decks, present ideas, and begin negotiations for potential partnerships or endorsements.
Progress Reports: At the end of the week, the marketing team compiles analytics data to evaluate the performance of the week's campaigns and social media

engagements, sharing insights with talent agents and the clients. In some example implementations, the Business Development & Partnerships Department may involve the following classes of entities:
Business Development Managers.
Partnership Managers.

An example weekly workflow of tasks for these entities may include:
New Market Research: The week starts with research into potential new markets, industries, or international expansion opportunities that align with clients'branding. Business development teams assess industry trends, opportunities for revenue diversification, and how to strategically place clients in these spaces.
Relationship Building: Partnership managers dedicate time to strengthening relationships with current brand partners and exploring new potential partners. Meetings and presentations take place to keep clients top of mind for new brand campaigns or activations.
Strategic Deal Negotiation: By midweek, the team actively engages in deal-making—negotiating terms, discussing campaign deliverables, and finalizing agreements with prospective brands for the client. Any legal concerns are worked out with the legal department to ensure compliance and optimal benefits.
Internal Collaboration: The partnership team meets with marketing, client services, and talent representation departments to coordinate upcoming projects, ensure alignment with client strategies, and confirm execution timelines.
Reporting: Business development teams generate weekly performance reports, highlighting completed deals, ongoing negotiations, and the projected financial impact of new deals.

In some example implementations, the Creative & Content Production Department may involve the following classes of entities:
Creative Directors.
Content Producers.
Designers.

An example weekly workflow of tasks for these entities may include:
Creative Brainstorming & Storyboarding: The week starts with brainstorming sessions to generate content ideas for clients'social media, branded content, and personal projects (such as podcasts or online shows). Storyboards, scripts, and visuals are drafted during the first half of the week.
Content Production & Editing: Once the content plan is approved, production begins. This involves coordinating photoshoots, video production, and graphics creation. Midweek is typically spent on production and fine-tuning creative content.
Collaboration with Marketing: The creative team collaborates closely with the marketing department to ensure the content fits within the broader marketing campaigns. By the end of the week, the content is submitted to the marketing team for review and distribution.
Client Feedback & Revisions: At the end of the week, content is presented to clients for feedback. Based on this input, the creative team makes necessary revisions before finalizing the content for release.

In some example implementations, the Legal & Contracts Department may involve the following classes of entities:
Contract Managers.
Legal Advisors.
Compliance Officers.

An example weekly workflow of tasks for these entities may include:
Contract Drafting & Review: At the start of the week, the legal team drafts or reviews contracts for upcoming brand partnerships, sponsorships, and endorsement deals. These contracts include compensation structures, deliverables, and compliance with industry regulations.
Risk Assessment: The legal department assesses potential risks associated with deals and partnerships. This involves compliance with industry standards (such as labor laws or intellectual property rights) and ensuring the best interests of clients are maintained.
Negotiation Support: Legal advisors collaborate with talent agents and partnership managers to negotiate deal terms, offering legal guidance during the negotiation process.
Finalization & Execution: By the end of the week, the legal team finalizes contracts, ensuring they are signed and executed appropriately by all parties. Any legal issues or disputes that arise are addressed and resolved with minimal disruption to the client's operations.

In some example implementations, the Client Success & Services Department may involve the following classes of entities:
Client Success Managers.
Talent Relations Specialists.
Account Managers.

An example weekly workflow of tasks for these entities may include:
Client Check-ins: The week begins with client check-ins, where client success managers review the progress on goals, address any concerns, and ensure satisfaction with ongoing campaigns and projects.
Goal Setting & Strategy Adjustments: Based on feedback, client success teams adjust strategies, offering new solutions or services that align with client goals. This could include proposing new sponsorships or content strategies.
Cross-Department Collaboration: Client success teams coordinate with marketing, creative, and business development departments to ensure all client activities align with their broader career strategy.
Reporting & Feedback: By the end of the week, the client success team generates detailed reports on the client's ongoing projects, campaign performance, and overall satisfaction. This report is shared with both the client and internal teams to ensure alignment.

In some example implementations, the talent provisioning and management system may be overseen by a C-Suite, which operates at a high strategic level, focusing on overall business growth, client satisfaction, leadership, and ensuring alignment between departments.

In some example implementations, the C-Suite may include a Chief Executive Officer (CEO) with the following example weekly workflow:
Strategic Planning & Vision Alignment: At the start of the week, the CEO sets the strategic direction for the agency, aligning with long-term goals. This includes overseeing key initiatives, growth opportunities, and potential mergers or acquisitions.
Executive Leadership Meetings: The CEO leads weekly executive team meetings to ensure that department heads are aligned with the company's strategic objectives. They provide high-level guidance, track progress, and address any bottlenecks in execution.
Client & Partner Relations: Throughout the week, the CEO engages with high-profile clients and key partners, ensuring relationships are strong and opportunities for collaboration or expansion are explored.
Decision-Making & Approvals: The CEO is responsible for making final decisions on major business deals, significant client engagements, or critical internal projects, collaborating with the COO, CFO, and other C-suite executives.
End-of-Week Reporting: The CEO reviews weekly reports from department heads to assess overall performance, challenges, and achievements.

In some example implementations, the C-Suite may include a Chief Operating Officer (COO) with the following example weekly workflow:
Operations Review: At the beginning of the week, the COO reviews the performance of ongoing operations and works with department heads to optimize efficiency and resolve any operational challenges.
Cross-Departmental Coordination: The COO ensures that all departments (client management, marketing, legal, creative) are working in sync. This involves organizing interdepartmental meetings and solving workflow issues that could slow down client projects.
Project Oversight: The COO tracks progress on large-scale initiatives and ensures that resources are allocated efficiently. They monitor timelines for client deliverables and ensure that each department is meeting its operational goals.
Client & Service Review: Midweek, the COO reviews client feedback and service delivery performance, working with client success teams to ensure high levels of client satisfaction.
Reporting to CEO: At the end of the week, the COO compiles operational reports, highlighting successes and areas of improvement for the CEO's review.

In some example implementations, the C-Suite may include a Chief Financial Officer (CFO) with the following example weekly workflow:
Financial Planning & Budget Review: At the start of the week, the CFO reviews the company's financial position, including budget adherence, cash flow, and revenue projections. They work closely with department heads to ensure financial strategies align with overall business goals.
Contract Review & Approval: The CFO collaborates with the legal and client management teams to review contracts, focusing on the financial terms of client deals and endorsements. They also ensure that these agreements align with financial goals and provide maximum profitability.
Investor & Stakeholder Relations: Midweek, the CFO engages with investors and stakeholders, providing financial updates and managing relationships to ensure continued trust and investment in the agency.
Financial Reporting & Forecasting: At the end of the week, the CFO prepares financial reports for the executive team and presents forecasts for the next quarter, making recommendations for budget reallocations or investment opportunities.

In some example implementations, the C-Suite may include a Chief Marketing Officer (CMO) with the following example weekly workflow:
Marketing Strategy Review: The week begins with a review of ongoing marketing campaigns for both the agency and its clients. The CMO ensures that campaigns are aligned with the brand's messaging and strategic goals.
Client Brand Development: The CMO meets with marketing teams to discuss client brand-building initiatives, ensuring that marketing efforts are yielding results and driving engagement. They review brand partnership opportunities and endorse potential high-value collaborations.
Collaboration with Creative Teams: Midweek, the CMO works with the creative team to refine marketing content, digital strategies, and overall campaign direction to ensure a strong market presence for clients.
Partnership Negotiations: Throughout the week, the CMO collaborates with business development teams to negotiate partnerships and sponsorships, ensuring deals are consistent with client branding strategies.
Performance Reporting: By the end of the week, the CMO reviews the performance of marketing efforts and presents insights to the executive team, proposing adjustments to upcoming campaigns and identifying new growth opportunities.

The C-Suite may include a Chief Talent Officer (CTO) with the following example weekly workflow:
Talent Management Review: The week begins with a review of client portfolios and career strategies, focusing on contract renewals, deal opportunities, and career milestones.
Client Negotiation Support: The CTO works closely with agents to negotiate deals, from contract renewals to endorsement opportunities. They provide guidance on high-value opportunities and ensure that client career goals are being met.
Client Retention & Satisfaction: Midweek, the CTO reviews client satisfaction reports to ensure that all talent is receiving top-tier representation. They may step in to resolve any major client issues and work on talent retention strategies.
Cross-Department Coordination: The CTO works with legal, marketing, and creative departments to ensure that all client projects are on track, meeting deadlines, and aligned with the client's long-term goals.
End-of-Week Client Reporting: The CTO compiles talent management reports to update the CEO and COO on key client successes, upcoming contract negotiations, and overall talent satisfaction.

In some example implementations, the C-Suite may include a Chief Legal Officer (CLO) with the following example weekly workflow:
Contract Drafting & Review: At the start of the week, the CLO reviews and drafts contracts for major deals, focusing on client agreements, partnerships, and endorsement contracts.
Compliance Monitoring: The CLO ensures that all client contracts comply with industry regulations and legal standards, collaborating with the finance and operations teams to avoid risk.
Risk Mitigation: Throughout the week, the CLO advises the executive team on potential legal risks related to client deals, acquisitions, or market expansion efforts, ensuring legal protection in all strategic decisions.
Negotiation Support: Midweek, the CLO provides legal support during contract negotiations, ensuring that the terms are favorable for both the agency and the client.
Weekly Legal Reporting: By the end of the week, the CLO presents a summary of ongoing legal cases, contract negotiations, and any risk mitigation strategies to the executive team.

In some example implementations, the C-Suite may include a Chief Business Development Officer (CBDO) with the following example weekly workflow:
Market Research & New Opportunities: At the beginning of the week, the CBDO conducts market research to identify emerging trends and potential areas of business growth, particularly in new markets or industries where talent representation can be expanded.
Partnership Outreach: The CBDO initiates outreach to prospective brand partners, investors, and sponsors, working with the marketing and legal teams to structure partnerships that align with the agency's long-term goals.
Deal Negotiations: Throughout the week, the CBDO is involved in negotiating high-value deals and collaborations that could lead to new revenue streams for the agency and its clients.
Reporting & Strategy Review: By the end of the week, the CBDO provides the executive team with an overview of potential deals in the pipeline, including new partnerships, sponsorships, and acquisitions that align with the company's growth strategy.

In some example implementations, the following is an example Condensed Weekly C-Suite Workflow Summary:
Monday: Strategic reviews, contract assessments, and departmental goal setting.
Tuesday: Execution of cross-departmental tasks, deal negotiation, and client/partner outreach.
Wednesday: Collaboration on projects, ensuring alignment with company goals; performance tracking and legal oversight.
Thursday: Continued partnership negotiations, strategy refinement, and client engagement.
Friday: Reporting, executive meetings to assess performance, and planning for the upcoming week.

In some examples, a Chief Brand Officer (CBO) may be responsible for overseeing the overall brand strategy and ensuring the agency's and its clients'brand identities are aligned with business objectives, fostering consistent growth, visibility, and reputation management. A detailed weekly workflow for the CBO is described below.

### 1. Monday: Brand Strategy Review

Strategic Planning: The CBO begins the week with a review of ongoing brand initiatives and campaigns, both for the agency and its clients. This includes reviewing branding strategies for top talent and major client campaigns.
Client Brand Development: Review and align client branding strategies with overall career objectives. Meet with marketing, talent management, and creative teams to ensure brand consistency across all platforms.
New Market Exploration: Collaborate with business development and marketing teams to identify new markets or audience segments where the agency and clients can expand their brand presence.

### 2. Tuesday: Cross-Department Collaboration

Marketing & Creative Collaboration: Work closely with the Chief Marketing Officer (CMO) and Creative Directors to refine campaigns, approve content, and ensure the brand messaging is consistent across media platforms.
Talent Brand Strategy Sessions: Meet with key talent management teams to discuss individual client brand-building initiatives. Review upcoming branding opportunities for high-profile clients and ensure alignment with long-term client goals.
Digital & Social Media Review: Collaborate with the digital and social media teams to ensure all brand activations and engagements align with the overall brand strategy. Review content plans and adjust if necessary to maximize audience impact.

### 3. Wednesday: Client & Agency Branding Initiatives

Client Brand Audit: Perform brand audits for key clients, assessing how well the current public perception aligns with their desired brand image. Collaborate with PR and marketing teams to refine messaging or adjust strategies.
Internal Brand Review: Work on strengthening the agency's internal brand, ensuring that its core values, vision, and market positioning are well communicated internally and externally. Review current PR campaigns and branding initiatives for the agency.
Partnership Discussions: Participate in discussions about partnership branding strategies, working with the Chief Business Development Officer (CBDO) to evaluate the brand impact of potential collaborations.

### 4. Thursday: Brand Activation & Market Performance

Brand Activation Planning: Review and approve brand activation plans for clients, including major launches, public appearances, sponsorships, and media campaigns.
Data & Performance Analytics: Analyze the performance of recent brand campaigns, using data analytics to measure reach, engagement, and return on investment (ROI). Meet with analytics teams to assess whether brand efforts are hitting key targets.
Public Relations Strategy: Work with the PR team to manage the agency's and clients'media presence, including handling any reputational risks or crisis management needs. Review upcoming media appearances, interviews, or speaking engagements for high-profile clients.

### 5. Friday: Reporting & Strategy Adjustments

Brand Strategy Reporting: Review and present brand strategy reports, including the performance of current initiatives, client feedback, and the market positioning of the agency and its clients. Present insights and potential adjustments to the CEO and executive team.
Client & Stakeholder Meetings: Host weekly meetings with key clients and stakeholders to provide updates on brand progress and receive feedback. Discuss new opportunities for brand partnerships or collaborations.
Future Planning: Work with the executive team to outline the next week's branding focus, including campaign launches, client strategy adjustments, and internal initiatives for improving brand perception. For another example, CBO Weekly Workflow Summary may include:
Monday: Review ongoing branding strategies for both the agency and key clients, and explore new branding opportunities.
Tuesday: Collaborate with the marketing, creative, and talent management teams to ensure brand alignment across platforms.
Wednesday: Conduct client and internal brand audits and discuss potential partnerships with business development teams.
Thursday: Plan and approve brand activations, analyze performance data, and oversee public relations strategies.
Friday: Present weekly brand performance reports, engage with clients and stakeholders, and plan upcoming branding initiatives.

As another example, the Director of Digital and Social Strategy plays a key role in managing online presence, digital campaigns, and social media strategy for both the agency and its clients. Their role involves collaboration across departments, leveraging data to optimize digital content, and ensuring that all digital and social initiatives align with overarching brand strategies.

An example weekly workflow of tasks above may include:

### 1. Monday: Digital Strategy Planning & Review

Strategic Review: Begin the week by reviewing the performance of existing digital and social campaigns. Analyze KPIs such as engagement rates, conversion metrics, and social media reach across platforms.
Campaign Planning: Collaborate with the marketing and creative teams to outline digital campaigns for clients and the agency. Focus on aligning digital content with the overarching marketing strategies and brand objectives. Set goals for the week, including new content launches, platform engagement strategies, and paid media campaigns.
Platform Optimization: Review the latest social media trends and platform algorithm changes (e.g., Instagram, TikTok, YouTube). Discuss with the team how these changes can impact strategies and content distribution.

### 2. Tuesday: Content Creation & Social Media Execution

Creative Briefing: Meet with the creative team and content producers to develop

digital assets (e.g., videos, infographics, posts) for upcoming campaigns. Ensure content aligns with client brand identities and campaign goals.
Social Media Calendar Management: Finalize the content calendar for the week, ensuring all posts, stories, and ads are scheduled and optimized for peak engagement. Review content themes, captions, and hashtags for alignment with strategy.
Influencer & Partner Collaboration: Coordinate with influencers or brand partners on content co-creation, ensuring partnerships align with client and agency goals. Finalize details on digital activations such as giveaways or sponsored content.

### 3. Wednesday: Paid Media and Analytics Review

Paid Media Management: Oversee the management of paid digital campaigns (e.g., Google Ads, Facebook Ads, Instagram campaigns). Work with the analytics and marketing teams to optimize ad spend and targeting. Adjust budgets and bidding strategies based on performance trends.
Performance Data Review: Dive deep into analytics dashboards (e.g., Google Analytics, social media insights) to evaluate how digital content is performing. Identify key trends, areas for improvement, and opportunities for optimizing future campaigns.
Cross-Department Alignment: Meet with the marketing, PR, and client

management teams to ensure the digital and social strategy aligns with overall client campaigns and broader brand strategies.

### 4. Thursday: Community Management & Engagement

Engagement Review: Monitor social media platforms and respond to comments, messages, and interactions across client and agency channels. Ensure community management is proactive, with quick responses to inquiries and comments.
Social Listening: Utilize social listening tools to track conversations around clients'brands and identify emerging trends, potential crises, or brand sentiment. Collaborate with PR and client services to address any potential issues.
Client Feedback: Review client feedback regarding social media and digital presence. Ensure any requests or adjustments are incorporated into future content plans and digital strategies.

### 5. Friday: Reporting & Strategy Adjustments

Weekly Performance Report: Compile a detailed report on the performance of digital campaigns, social media metrics, and influencer partnerships for both the agency and its clients. Highlight areas of success and opportunities for improvement.
Strategy Review & Adjustments: Present digital and social media insights to the executive team. Based on performance data and social media trends, make recommendations for refining digital strategies moving forward.
Next Week Planning: Prepare for the next week by reviewing upcoming digital and social initiatives, confirming content production schedules, and aligning with key stakeholders on priorities for the following week.

Another example Weekly Workflow Summary is below:
Monday: Review and plan digital strategies and campaigns.
Tuesday: Execute content creation and manage social media calendars.
Wednesday: Oversee paid media and review performance analytics.
Thursday: Engage with communities, monitor social listening, and incorporate client feedback.
Friday: Report on campaign performance and adjust strategies for the upcoming week.

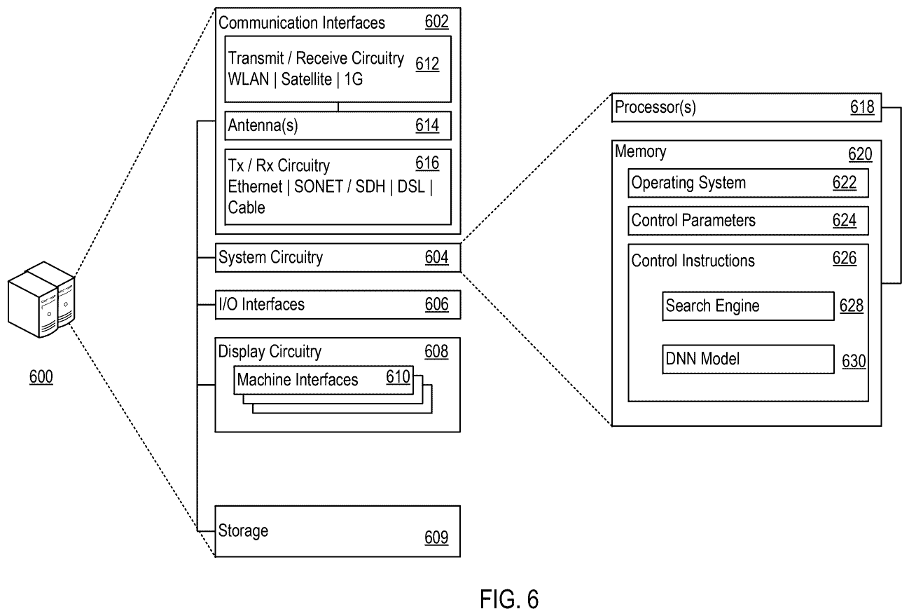

The methods in the various example implementations above may be performed by a computing system in a computer network including various computing devices or components. FIG. 6 illustrates an example architecture of such a computing device 600. The computing device 600 may include communication interfaces 602, system circuitry 604, input/output (I/O) interface circuitry 606, and display circuitry 608. The graphical user

interfaces (GUIs) 610 displayed by the display circuitry 608 may be used to receive user commands/input and to display various outputs. The I/O interface may include circuity that facilitate communication with the example devices above (e.g., sensors and UV light source, represented as “imaging setup” 601) for output control signals and for input detection signals. The GUIs 610 may be displayed locally using the display circuitry 608, or for remote visualization, e.g., as HTML, JavaScript, audio, and video output for a web browser running on a local or remote machine.

The GUIs 610 and the I/O interface circuitry 606 may include touch sensitive displays, voice or facial recognition inputs, buttons, switches, speakers and other user interface elements. Additional examples of the I/O interface circuitry 606 includes microphones, video and still image cameras, headset and microphone input/output jacks, Universal Serial Bus (USB) connectors, memory card slots, and other types of inputs. The I/O interface circuitry 606 may further include magnetic or optical media interfaces (e.g., a CDROM or DVD drive), serial and parallel bus interfaces, and keyboard and mouse interfaces. The graphical analysis above, for example, the wavelength-resolved UV image of the target, may be displayed as user interface elements for visualization and/or for interactive purposes.

The communication interfaces 602 may include wireless transmitters and receivers (“transceivers”) 612 and any antennas 614 used by the transmit and receive circuitry of the transceivers 612. The transceivers 612 and antennas 614 may support WiFi network communications, for instance, under any version of IEEE 802.11, e.g., 802.11n or 802.11ac, or other wireless protocols such as Bluetooth, Wi-Fi, WLAN, cellular (4G, LTE/A). The communication interfaces 602 may also include serial interfaces, such as universal serial bus (USB), serial ATA, IEEE 194, lighting port, I2C, slimBus, or other serial interfaces. The communication interfaces 602 may also include wireline transceivers 616 to support wired communication protocols. The wireline transceivers 616 may provide physical layer interfaces for any of a wide range of communication protocols, such as any type of Ethernet, Gigabit Ethernet, optical networking protocols, data over cable service interface specification (DOCSIS), digital subscriber line (DSL), Synchronous Optical Network (SONET), or other protocol.

The system circuitry 604 may include any combination of hardware, software, firmware, APIs, and/or other circuitry. The system circuitry 604 may be implemented, for example, with one or more systems on a chip (SoC), application specific integrated circuits (ASIC), microprocessors, discrete analog and digital circuits, and other circuitry. The system circuitry 604 may implement any desired functionality of the disclosed system and its various components. As just one example, the system circuitry 604 may include one or more instruction processor 618 and memory 620.

The memory 620 may be implemented as a non-transitory memory circuit and may store, for example, control instructions 622 for implementing the various functions described above, as well as an operating system 621. In one implementation, the processor 618 executes the control instructions 622 and the operating system 621 to carry out any desired functionality of the various components above, including but not limited to the embedding functions 623, link prediction and evaluation functions 603, rule extraction and feedback knowledge graph generation functions 605, and consensus extraction functions 607.

The computing device 600 may further include various data sources and databased such as knowledge graphs 630, or may be in communication with external data sources. Each of the databases that are included in the data sources and knowledge graphs 630 may be accessed by the various component of the disclosed system and its components.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein may be employed.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

Finally, in FIG. 6, an example computing architecture 600 that may be implemented in any of the processing and storage component above is shown, including communication interfaces 602, system circuitry 604, input/output (I/O) interfaces 606, storage 809, and display circuitry 808 that generates machine interfaces 610 (such as the user interfaces described above) locally or for remote display, e.g., in a web browser running on a local or remote machine. The machine interfaces 610 and the I/O interfaces 806 may include GUIs, touch sensitive displays, voice or facial recognition inputs, buttons, switches, speakers and other user interface elements. Additional examples of the I/O interfaces 806 include microphones, video and still image cameras, headset and microphone input/output jacks, Universal Serial Bus (USB) connectors, memory card slots, and other types of inputs. The I/O interfaces 806 may further include magnetic or optical media interfaces (e.g., a CDROM or DVD drive), serial and parallel bus interfaces, and keyboard and mouse interfaces.

The communication interfaces 602 may include wireless transmitters and receivers (“transceivers”) 612 and any antennas 614 used by the transmitting and receiving circuitry

of the transceivers 612. The transceivers 612 and antennas 614 may support Wi-Fi network communications, for instance, under any version of IEEE 802.11, e.g., 802.11n or 802.11ac. The communication interfaces 602 may also include wireline transceivers 616. The wireline transceivers 816 may provide physical layer interfaces for any of a wide range of communication protocols, such as any type of Ethernet, data over cable service interface specification (DOCSIS), digital subscriber line (DSL), Synchronous Optical Network (SONET), or other protocol. Computers using the computing architecture of 600 may communicate with one another via the communication interface 602 and the communication network 601.

The storage 809 may be used to store various initial, intermediate, or final data or model for implementing the functionalities of the knowledge pattern machine and the various other computing components described above. The storage 609 may be centralized or distributed. For example, the storage 609 may be hosted remotely by a cloud computing service provider.

The system circuitry 604 may include hardware, software, firmware, or other circuitry in any combination. The system circuitry 604 may be implemented, for example, with one or more systems on a chip (SoC), application specific integrated circuits (ASIC), microprocessors, discrete analog and digital circuits, and other circuitry. The system circuitry 604 is part of the implementation of any desired functionality related to the knowledge pattern machine. As just one example, the system circuitry 604 may include one or more instruction processors 618 and memories 620. The memories 620 may store, for example, control instructions 624 and an operating system 622. In one implementation, the instruction processors 618 may execute the control instructions 624 and the operating system 622 to carry out any desired functionality related to the functionalities of the knowledge pattern machine described above.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (and may store instructions that perform any of the processing described above or illustrated in the drawings, when executed by the circuitry.

It is to be understood that the various implementations above are not limited in its application to the details of construction and the arrangement of components set forth above and in the accompanying drawings. The disclosure is intended to cover other embodiments that may be practiced or carried out in various ways following the underlying principles disclosed herein.

It should also be noted that a plurality of hardware and software-based devices, as well as a plurality of different structural components, may be used to implement the various embodiments of the disclosure. In addition, it should be understood that embodiments of this disclosure may include hardware, software, and electronic components or modules that, for purposes of discussion, may be illustrated and described as if the majority of the components are implemented solely in hardware. However, one of the ordinary skills in the art, and based on a reading of this disclosure, would recognize that, in at least one embodiment, the electronic-based aspects of the invention may be implemented in software (e.g., stored on a non-transitory computer-readable medium) executable by one or more processors. As such, it should be noted that a plurality of hardware and software-based devices, as well as a plurality of different structural components, may be utilized to implement the invention. Furthermore, and as described in subsequent paragraphs, the specific mechanical configurations illustrated in the drawings are intended to exemplify embodiments of the invention and that other alternative mechanical configurations are possible. For example, “controllers” described in the specification can include standard processing components, such as one or more processors, one or more computer-readable medium modules, one or more input/output interfaces, and various connections (e.g., a system bus) connecting the components. These controllers may be implemented as dedicated processing circuitry or in general-purpose processors, in combination of various software and/or firmware, and in combination of other wired or wireless communication interfaces.

1. A method, comprising at least one of:
generating adapted scripts using a first pre-trained model for scraping at least one external data sources to obtain a source dataset;
identifying at least one entity and at least one object from the source dataset;
generating a plurality of profiles for the at least one entity according to the source dataset using a second pre-trained model, each of the plurality of profiles comprising at least one structured data item and at least one unstructured data item;
generating a graphical dataset for representing the at least one entity and the at least one object and relationships there of as extracted from the source dataset; and
identifying at least one matching pair between the at least one entity and the at least one object by processing the plurality of profiles and the graphical dataset.

2. The method of claim 1, wherein the adapted scripts are generated via a user registration procedure.

3. The method of claim 2, where the user registration procedure comprises generating a sequency of adapted inquiries via a user interface for the at least one entity, a later inquiry being adaptively generated by a pre-trained inquiry model based on at least one prior inquiry and at least one response to the prior inquiry provided by the at least one entity.

4. The method of claim 1, wherein the at least one entity comprises a plurality of individual talents and the at least one object comprises a plurality of brands, venues, events, or service offerings.

5. The method of claim 1, wherein identifying the at least one matching pair is triggered by one of the at least one entity via a user interface.

6. The method of claim 5, wherein the user interface comprises a chat box for the at least one entity to trigger the identification of the at least one matching pair by entering textual input in the chat box.

7. The method of claim 1, wherein:
the graphical dataset comprises a plurality of nodes representing the at least one entity and the at least one object and a plurality of edges connecting the plurality of nodes; and
identifying the at least one matching pair is based on predicting a most probably non-existed connection between an entity and an object in the graphical dataset.

8. A electronic system comprising a memory for storing instructions and at least one processor configured to execute the instructions to:
generate adapted scripts using a first pre-trained model for scraping at least one external data sources to obtain a source dataset;
identify at least one entity and at least one object from the source dataset;
generate a plurality of profiles for the at least one entity according to the source dataset using a second pre-trained model, each of the plurality of profiles comprising at least one structured data item and at least one unstructured data item;
generate a graphical dataset for representing the at least one entity and the at least one object and relationships there of as extracted from the source dataset; and
identify at least one matching pair between the at least one entity and the at least one object by processing the plurality of profiles and the graphical dataset.

9. The electronic system of claim 8, wherein the adapted scripts are generated via a user registration procedure.

10. The electronic system of claim 9, where the user registration procedure comprises generating a sequency of adapted inquiries via an user interface for the at least one entity, a later inquiry being adaptively generated by a pre-trained inquiry model based on at least one prior inquiry and at least one response to the prior inquiry provided by the at least one entity.

11. The electronic system of claim 8, wherein the at least one entity comprises a plurality of individual talents and the at least one object comprises a plurality of brands, venues, events, or service offerings.

12. The electronic system of claim 8, wherein to identify the at least one matching pair is triggered by one of the at least one entity via a user interface.

13. The electronic system of claim 12, wherein the user interface comprises a chat box for the at least one entity to trigger the identification of the at least one matching pair by entering textual input in the chat box.

14. The electronic system of claim 8, wherein:
the graphical dataset comprises a plurality of nodes representing the at least one entity and the at least one object and a plurality of edges connecting the plurality of nodes; and
to identify the at least one matching pair is based on predicting a most probably non-existed connection between an entity and an object in the graphical dataset.

15. A computer-readable non-transitory storage medium for storing instructions, wherein the instructions, when executed by a processor of a electronic system, are configured to cause the electronic system to:
generate adapted scripts using a first pre-trained model for scraping at least one external data sources to obtain a source dataset;
identify at least one entity and at least one object from the source dataset;
generate a plurality of profiles for the at least one entity according to the source dataset using a second pre-trained model, each of the plurality of profiles comprising at least one structured data item and at least one unstructured data item;
generate a graphical dataset for representing the at least one entity and the at least one object and relationships there of as extracted from the source dataset; and
identify at least one matching pair between the at least one entity and the at least one object by processing the plurality of profiles and the graphical dataset.

16. The computer-readable non-transitory storage medium of claim 15, wherein the adapted scripts are generated via a user registration procedure.

17. The computer-readable non-transitory storage medium of claim 16, where the user registration procedure comprises generating a sequency of adapted inquiries via an user interface for the at least one entity, a later inquiry being adaptively generated by a pre-trained inquiry model based on at least one prior inquiry and at least one response to the prior inquiry provided by the at least one entity.

18. The computer-readable non-transitory storage medium of claim 15, wherein to identify the at least one matching pair is triggered by one of the at least one entity via a user interface.

19. The computer-readable non-transitory storage medium of claim 18, wherein the user interface comprises a chat box for the at least one entity to trigger the identification of the at least one matching pair by entering textual input in the chat box.

20. The computer-readable non-transitory storage medium of claim 15, wherein:
the graphical dataset comprises a plurality of nodes representing the at least one entity and the at least one object and a plurality of edges connecting the plurality of nodes; and
to identify the at least one matching pair is based on predicting a most probably non-existed connection between an entity and an object in the graphical dataset.
